(19) United States
(12) Patent Application Publication
(10) Pub. No.: US 2024/0227651 A1
(43) Pub. Date: Jul. 11, 2024

(54) PLASTIC ARTICLE WITH FAUX STITCHING AND METHOD OF FORMING SAME

(71) Applicant: THERMOFLEX CORP., Waukegan, IL (US)

(72) Inventors: Robert PRICE, Mettawa, IL (US); Michael VOGLER, Waukegan, IL (US)

(21) Appl. No.: 18/409,368

(22) Filed: Jan. 10, 2024

Related U.S. Application Data
(60) Provisional application No. 63/479,445, filed on Jan. 11, 2023.

(51) Int. Cl. B60N 3/04; B29C 45/14; B29K 21/00; B29L 31/30; B32B 3/30; B32B 27/08; B60R 13/02

(52) U.S. Cl. CPC B60N 3/048; B29C 45/14688; B32B 3/30; B32B 27/08; B60N 3/044; B60R 13/02; B29K 2021/003; B29K 2995/0097; B29L 2031/3005; B29L 2031/3017; B32B 2307/7376; B32B 2471/04; B32B 2605/003

(57) ABSTRACT

A plastic article with faux stitching, comprising an applique having a front side and a rear side opposite the front side, and formed of a preformed plastic sheet; a molded plastic platform; wherein the applique is insert-molded to the platform with the rear side of the applique bonded with the platform; wherein at least one faux stitch line is formed on the front side of the applique; wherein the at least one faux stitch line comprises faux stitches, which each comprise a stress-whitened region of the applique.

### CROSS-REFERENCE TO RELATED APPLICATIONS

This application claims the benefit of U.S. provisional patent application Ser. No. 63/479,445, filed Jan. 11, 2023, which is incorporated by reference in its entirety.

### FIELD

The present disclosure relates to a plastic article with faux stitching, and more particularly an interior trim article of a motor vehicle with faux stitching, such as a floor mat.

### BACKGROUND

Stitching formed with a thread may be provided on plastic articles, however such is often cost prohibitive.

Faux stitching may be formed with a plastic article, however such is known to the same color of the article, which makes it easily discernable that such is not real stitching, i.e. stitching formed with thread.

The present disclosure provides a plastic article with faux stitching which appears more like real stitching, particularly by the stitching having a different color than the color of the article.

### SUMMARY

The present disclosure provides faux stitching which is integrated with a plastic article at the time of forming the article.

In at least one embodiment, a plastic article with faux stitching is provided, comprising an applique having a front side and a rear side opposite the front side, and formed of a thermoformed plastic sheet; an injection molded plastic platform; wherein the applique is insert-molded to the platform with the rear side of the applique bonded with the platform; wherein at least one faux stitch line is formed on the front side of the applique; wherein the at least one faux stitch line comprises a plurality of faux stitches; and wherein each faux stitch of the plurality of faux stitches comprises a stress-whitened region of the applique.

In at least one embodiment, the front side of the applique further includes a plurality of raised pleats.

In at least one embodiment, the at least one faux stitch line at least partially surrounds at least one raised pleat of the plurality of raised pleats.

In at least one embodiment, the at least one faux stitch line is disposed between adjacent raised pleats of the plurality of raised pleats.

In at least one embodiment, the at least one faux stitch line is disposed on at least one stitch path; wherein the at least one stitch path is disposed between adjacent raised pleats of the plurality of raised pleats; and wherein the at least one stitch path borders the adjacent raised pleats.

In at least one embodiment, the at least one faux stitch line comprises a plurality of faux stitch lines; wherein the plurality of faux stitch lines each comprise a respective plurality of the faux stitches; wherein each faux stitch of the respective plurality of faux stitches comprises a respective stress-whitened region of the applique; and the plurality of faux stitch lines completely surround the plurality of raised pleats.

In at least one embodiment, the plurality of raised pleats each have a matching polygon shape.

In at least one embodiment, the polygon shape is a quadrilateral shape.

In at least one embodiment, the plurality of faux stitch lines are disposed on a plurality of respective stitch paths; wherein the plurality of respective stitch paths are disposed between respective adjacent raised pleats of the plurality of raised pleats; and wherein the plurality of respective stitch paths completely border the respective adjacent raised pleats.

In at least one embodiment, the injection molded plastic platform is formed of an elastomer; and/or the injection molded plastic platform has a thickness in a range of 1.5 mm to 3.5 mm.

In at least one embodiment, the thermoformed plastic sheet is formed of a thermoplastic; and/or the thermoformed plastic sheet has a thickness in a range of 0.1 mm to 1.5 mm.

In at least one embodiment, the article has an outer face having a region provided by the front side of a plastic applique and a region provided by a front side of the injection molded plastic platform, which is adjacent the front side of the plastic applique.

In at least one embodiment, the faux stitches which each comprise a respective stress-whitened region of the applique each have a longitudinal length in a range of 1 mm to 4 mm, and/or a width perpendicular to the longitudinal length in a range of 0.1 mm to 0.9 mm.

In at least one embodiment, the faux stitches which each comprise a stress-whitened region of the applique each have a different color than a bordering region of the applique bordering the faux stitches.

In at least one embodiment, the plastic article is an interior trim article of a motor vehicle.

In at least one embodiment, the plastic article is a floor mat and/or a floor tray.

In at least one embodiment, a method to form a plastic article with faux stitching is provided, the method comprising inserting an applique having a front side and a rear side opposite the front side in a molding cavity of an injection mold, wherein the applique is formed of a thermoformed plastic sheet; injecting plastic into the molding cavity, which forms an injection molded plastic platform, with the rear side of the applique bonded with the platform; and forming at least one faux stitch line on the front side of the applique, wherein the at least one faux stitch line comprises faux stitches, wherein the faux stitches each comprise a stress-whitened region of the applique formed during injecting of the plastic into the molding cavity.

In at least one embodiment, the front side of the applique further includes a plurality of raised pleats prior to being inserted in the molding cavity of the injection mold; and the at least one faux stitch line at least partially surrounds at least one pleat of the plurality of raised pleats.

In at least one embodiment, the method further comprises forming a plurality of faux stitch line on the front side of the applique, wherein the plurality of faux stitch lines each comprises faux stitches, wherein the faux stitches each comprise a stress-whitened region of the applique formed during injecting of the plastic into the molding cavity; and wherein the plurality of faux stitch lines completely surround the plurality of raised pleats.

In at least one embodiment, the method further comprises the article having an outer face having a region provided by the front side of a plastic applique and a region provided by a front side of the injection molded plastic platform, which is adjacent the front side of the plastic applique.

### BRIEF DESCRIPTION OF THE DRAWINGS

The above-mentioned and other features of this disclosure, and the manner of attaining them, will become more apparent and better understood by reference to the following description of embodiments described herein taken in conjunction with the accompanying drawings, wherein:

FIG. 1 is a front plan view of an article of the present disclosure;

FIG. 2 is a close-up view of an applique section of the plan view of the article of FIG. 1;

FIG. 3 is a close-up view of a pleat of the applique section of FIG. 2;

FIG. 4 is a plan view of a mold to form the article of FIG. 1;

FIG. 5 is a close-up view of a section of a molding surface of the mold of FIG. 4;

FIG. 6 is a plan view of the applique prior to forming the article;

FIG. 7 is a close-up view of an applique section of the applique of FIG. 6; and

FIG. 8 is a plan view of the mold of FIG. 4 with the applique disposed thereon.

### DETAILED DESCRIPTION

It may be appreciated that the present disclosure is not limited in its application to the details of construction and the arrangement of components set forth in the following description or illustrated in the drawings. The invention(s) herein may be capable of other embodiments and of being practiced or being carried out in various ways. Also, it may be appreciated that the phraseology and terminology used herein is for the purpose of description and should not be regarded as limiting as such may be understood by one of skill in the art.

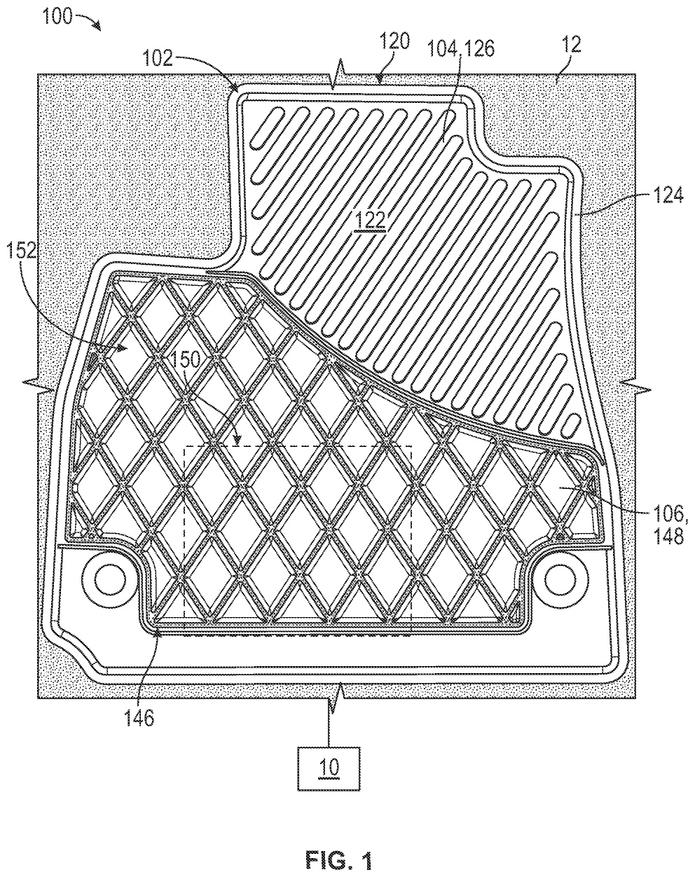

Referring now to the figures, FIG. 1 shows a plastic article 100, particularly as an interior trim article of a motor vehicle 10, and more particularly as a floor article, such as a floor mat/tray, which may be disposed on flooring 12 of the motor vehicle 10. As shown, the flooring 12 may comprise a carpet disposed in a passenger area or a cargo area.

As shown, the plastic article 100 comprises a plastic molded platform 120 (e.g. injection molded) having a planar, horizontal base wall 122 (which may also be referred to as a foundation wall or floor) at least partially surrounded by a vertically raised perimeter rim 124 (which may be referred to a vertically raised containment wall). As shown, the perimeter rim 124 extends continuously around the base wall 122. It should be understood that the perimeter rim 124 is preferably continuous/uninterrupted around that base wall 122 in that the base wall 122 is completely surrounded/enclosed by the perimeter rim 124 on all bordering sides (i.e. 360 degrees). In other embodiments, the perimeter rim 124 may be discontinuous/intermittent around the base wall 122. For example, the perimeter rim 124 may be discontinuous/intermittent around the base wall 122 at one or more sides of the base wall 122 or may be completely eliminated at one or more sides of the base wall 122. It should also be understood that base wall 122 is referred to as being horizontal, and the perimeter rim 124 is referred to as being vertical, are in the context of a floor article or other article in which the base wall 122 is arranged horizontal, but may not be arranged as such for other applications.

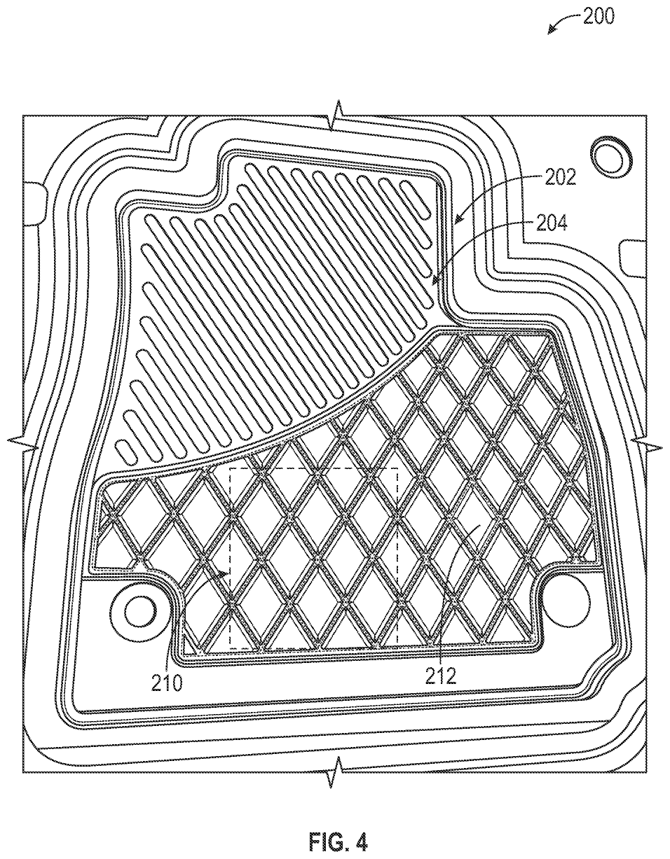

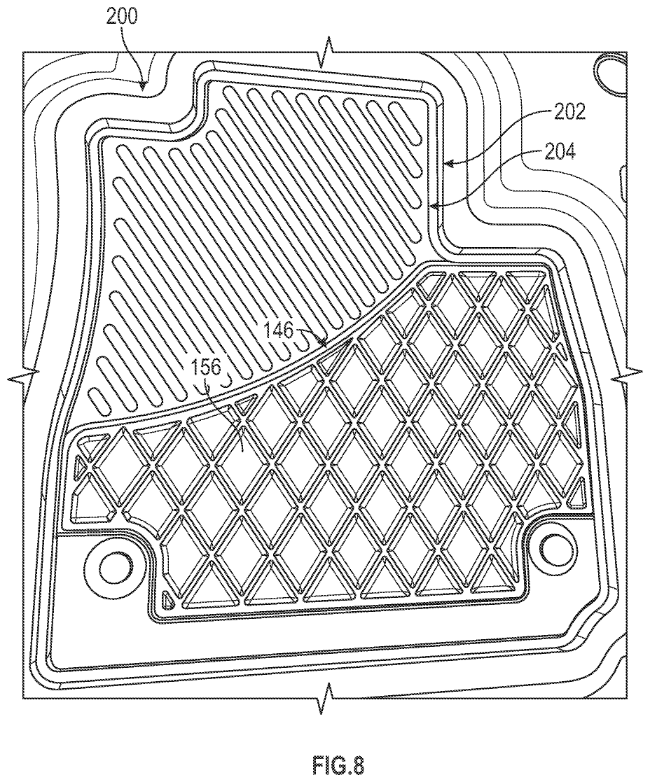

As shown, a separately formed plastic applique 146 is attached, particularly by being insert-molded to the platform 120 during injection molding of the platform 120. Insert injection molding may be understood as a process in which a component is inserted into a mold 200 (FIG. 4) prior to the introduction of heated/melted plastic during injection. As shown, the outer (front) face 102 of the article 100 comprises a platform outer (front) face region 104 and an applique outer (front) face region 106, provided by a front side 148 of the applique 146. In the applique region 106 of the front face 102 of the article 100, the platform 120, particularly the base wall 122, underlies the applique 146. More particularly, a front side 126 of the platform 120, particularly the base wall 122, faces a rear side 156 (FIG. 8) of the applique 146 (which is opposite the front side 148) with both sides 126, 156 thermally bonded (in-mold welded) together, without need for use of a separate adhesive.

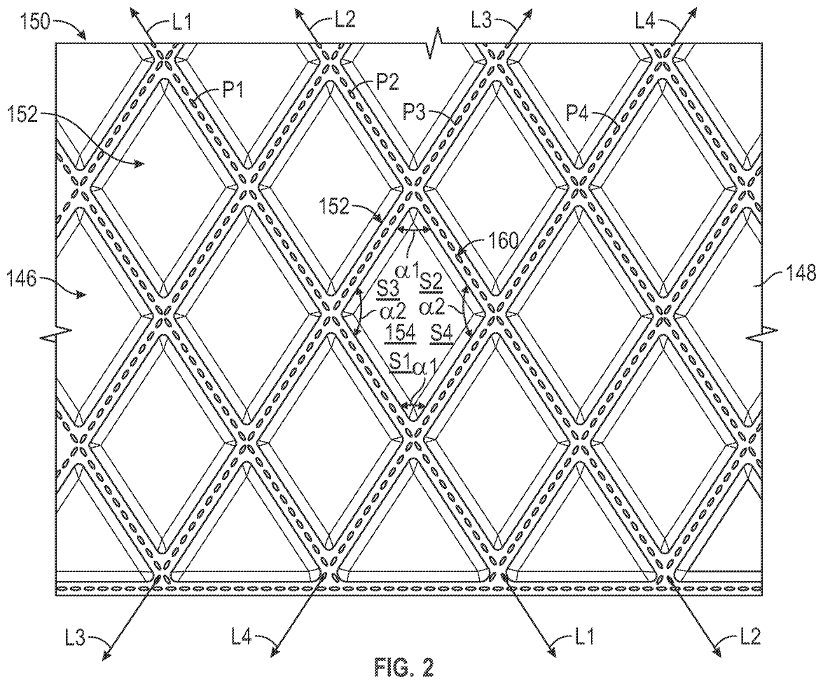

As best shown by FIG. 2, there is shown a section 150 of the applique outer (front) face region 106 of the front face 102 of the article 100 of FIG. 1, which is provided by the front side 148 of the applique 146, has a plurality of adjacent, matching, polygon (quadrilateral) shaped raised pleats 152. More particularly, the raised pleats 152 are shown having a diamond shape formed by parallelograms, and more particularly rhombuses, with two angles α1 between intersecting angled sides S1, S4 and S2, S3 being less than 90 degrees and two other angles α2 between intersecting angled sides S1, S3 and S2, S4 being more than 90 degrees. More particularly, angles α1 may be in a range of 60 degrees to 85 degrees, and angles α2 may be in a range of 95 degrees to 120 degrees.

As shown, on the applique outer (front) face region 106 of the front face 102 of the article 100 (which, again, is provided by the front side 148 of the applique 146), a perimeter/periphery of each pleat 152 is at least partially, and more particularly completely, surrounded by four elongated, adjacent, linear faux stitch lines L1, L2, L3 and L4, which are disposed between adjacent pleats 152 and are recessed relative to the front surface 154 of pleats 152. The pair of stitch lines L1, L2 are substantially parallel (e.g. within 5 degrees of being parallel inclusive of being parallel) with each other, while the pair of stitch lines L3, L4 are substantially parallel (e.g. within 5 degrees of being parallel inclusive of being parallel) with each other. The pair of stitch lines L1, L2 and the pair of stitch lines L3, L4 are transverse to one another. The stitch lines L1-L4 are substantially parallel (e.g. within 5 degrees of being parallel inclusive of being parallel) with corresponding sides S1-S4 of the pleat 152.

The stitch lines L1, L2, L3 and L4 are disposed on corresponding elongated, linear stitch paths P1, P2, P3 and P4, which are disposed between adjacent pleats 146 and are recessed relative to the front surface 154 of pleats 152. As shown, the perimeter/periphery of each pleat 152 is bordered and defined by the stitch paths P1-P4. As shown, the pair of stitch paths P1, P2 are substantially parallel (e.g. within 5 degrees of being parallel inclusive of being parallel) with each other, while the pair of stitch paths P3, P4 are substantially parallel (e.g. within 5 degrees of being parallel inclusive of being parallel) with each other. The pair of stitch paths P1, P2 and the pair of stitch paths P3, P4 are transverse to one another. The stitch paths P1-P4 are substantially parallel (e.g. within 5 degrees of being parallel inclusive of being parallel) with corresponding sides S1-S4 of the pleats 152.

Also as shown, stitch line L1/stitch path P1 are substantially parallel (e.g. within 5 degrees of being parallel inclusive of being parallel) with each other. Similarly, stitch line L2/stitch path P2; stitch line L3/stitch path P3, and stitch line L4/stitch path P4 are each substantially parallel (e.g. within 5 degrees of being parallel inclusive of being parallel) with each other.

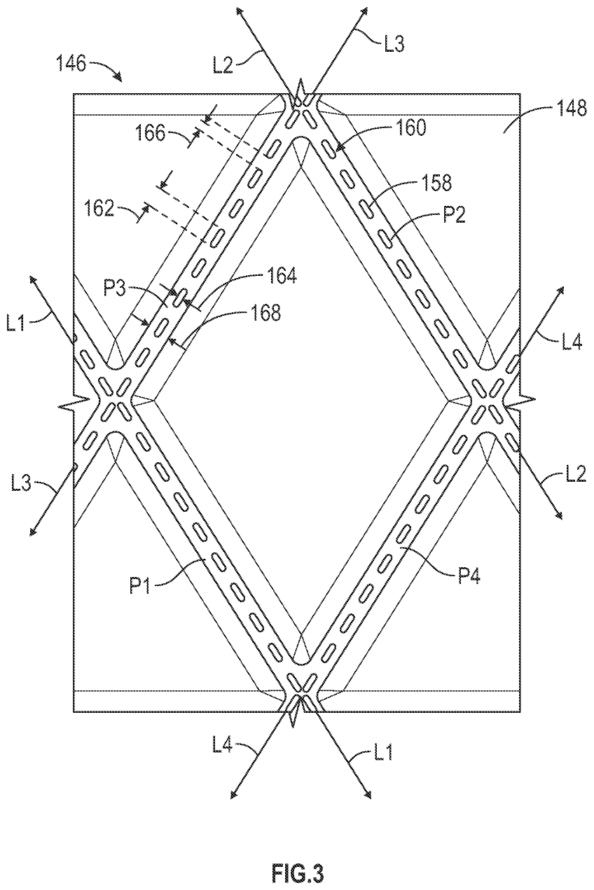

As best shown by FIG. 3, the stitch lines L1-L4 comprises a plurality of stitches 160 arranged end to end. Each stitch 160 may have a longitudinal stitch length 162 in a range of 1 mm to 4 mm, a stitch width 164 (perpendicular to the longitudinal length) in a range of 0.1 mm to 0.9 mm, and a longitudinal stitch (spacing) gap of 166 may be in a range of 0.25 mm to 1 mm. The stitch paths P1-P4 may have a width 168 in a range of 0.75 mm to 2.25 mm.

As explained in greater detail below, plastic molded platform 120 may particularly be formed of a polymer composition, such as a thermoplastic polymer composition, using injection molding, at a wall thickness in a range of 1.5 mm to 3.5 mm, and more particularly 2.0 mm to 3.0 mm. In certain applications (e.g. floor mats), the polymer composition may be an elastomer polymer composition, such as a thermoplastic elastomer polymer composition.

The elastomer polymer composition may be polymer composition with a glass transition temperature (Tg) below 23° C. and which is at most, 50% crystalline (i.e., the composition contains an amorphous phase of 50% or greater, up to 100% amorphous phase). Additionally or alternatively, the elastomer polymer composition may be a polymer composition that has an elongation at 23° C. of at least 100%, and which, after being stretched to twice its original length and being held at such for one minute, may recover in a range of 50% to 100% within one minute after release from the stress. More particularly, the elastomer polymer composition may recover in a range of 75% to 100% within one minute after release from the stress, and even more particularly recover in a range of 90% to 100% within one minute after release from the stress.

The elastomer of the elastomer polymer composition may comprise, essentially consist of or consist of thermoset or thermoplastic elastomer such as acrylic rubber, butadiene rubber, butyl rubber, ethylene propylene rubber, ethylene propylene rubber diene monomer rubber, fluorocarbon rubber, isoprene rubber, nitrile rubber including hydrogenated nitrile rubber, polyurethane rubber, silicone rubber and styrene block copolymer rubber (e.g. styrene butadiene rubber, styrene ethylene/butylene styrene rubber).

In certain applications, the plastic molded platform 120 may be formed of a rigid polymer composition, such as a rigid thermoplastic polymer composition. The rigid polymer composition may be a polymer composition which has a three-point bending flexural modulus, as measured by ASTM D790-10, of greater than 146,000 psi., and more particularly greater than 200,000 psi. Additionally or alternatively, the rigid polymer composition may have a Shore D durometer hardness, as measured by ASTM D2240-05 (2010), in a range of 55-90 Shore D durometer hardness.

The rigid polymer of the rigid polymer composition may comprise, essentially consist of or consist of thermoset or thermoplastic rigid polymer, such as polyolefin (e.g. polypropylene, polyethylene, acrylonitrile-butadiene-styrene, polycarbonate, polyamide, polyimide, polyurethane, polyester and mixtures thereof.

Applique 146 may particularly be formed of a polymer composition, such as a thermoplastic polymer composition, which is first extruded as a planar (two-dimensional) plastic sheet, at a wall thickness of 0.1 mm to 1.5 mm, and more particularly 0.25 mm to 1.0 mm. The extruded plastic sheet may be cut into separate planar sheet pieces/segments and thermoformed into a three-dimensional shape, with vacuum (assist) forming, i.e. forming the sheet pieces/segments with assistance of negative (less than atmospheric) pressure and/or pressure (assist) forming, i.e. forming the sheet pieces/segments with assistance of positive (greater than atmospheric) pressure, to provide the applique 146 preformed with the pleats 152 prior to molding the plastic molded platform 120 thereto.

Applique 146 may more particularly be formed of a rigid polymer composition, such as a rigid thermoplastic polymer composition. As with the plastic molded platform 120, the rigid polymer of the rigid polymer composition may comprise, essentially consist of or consist of thermoset or thermoplastic rigid polymer, such as polyolefin (e.g. polypropylene, polyethylene, acrylonitrile-butadiene-styrene, polycarbonate, polyamide, polyimide, polyurethane, polyester and mixtures thereof.

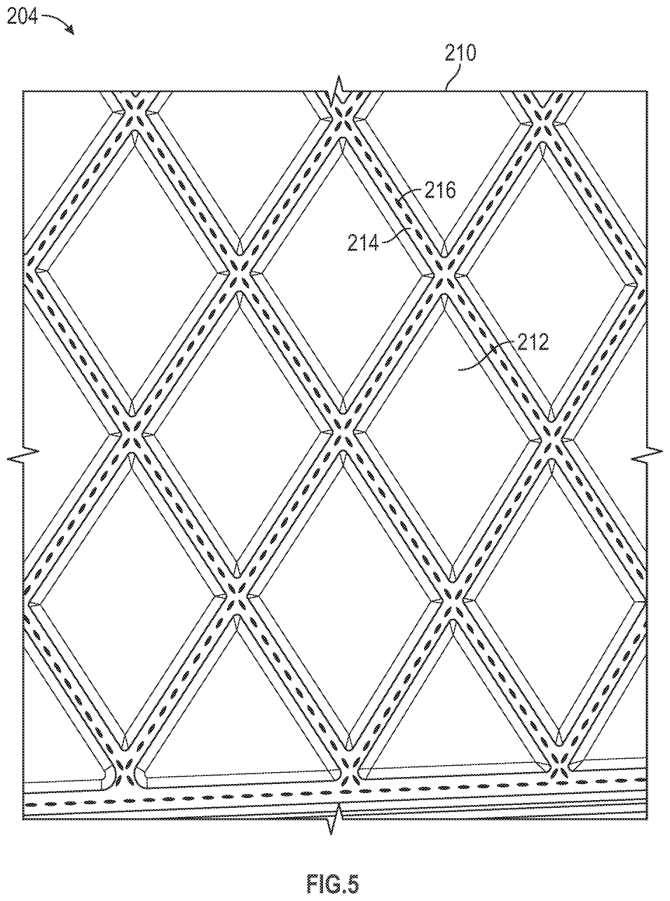

Referring now to FIG. 4, there is shown an injection mold 200, and more particularly the injection mold half to form the outer (front) face 102 of the article 100, with a molding cavity 202 having a molding surface 204. Referring to FIG. 5, there is shown a section 210 of the molding surface 204 of the molding cavity 202 of mold 200 of FIG. 4 which is used to form applique outer (front) face region 106 of the article 100. As best shown in FIG. 5, the mold surface 204 includes pleat recesses 212 to receive the receive the pleats 152 of the applique 146, as well as elongated stitch path supports 214, to support stitch paths P1-P4, which include stitch recesses 216 to form stitches 160.

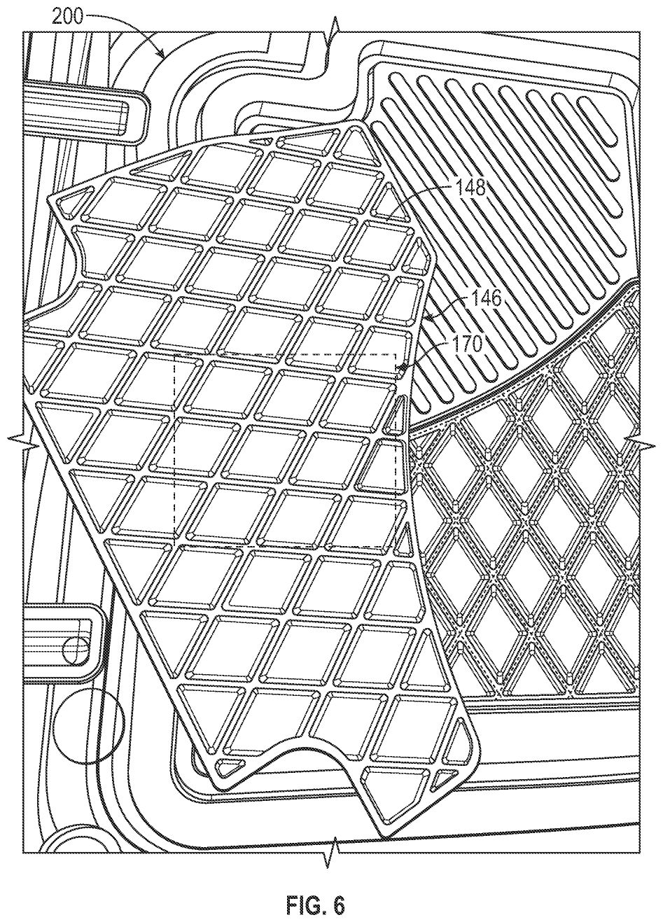

Referring now to FIG. 6 there is shown the injection mold 200, and more particularly the injection mold half to form the outer (front) face 102 of the article 100, along with the front side 148 of the applique 146 (which forms the applique outer (front) face region 106 of the front face 102 of the article 100) after thermoforming.

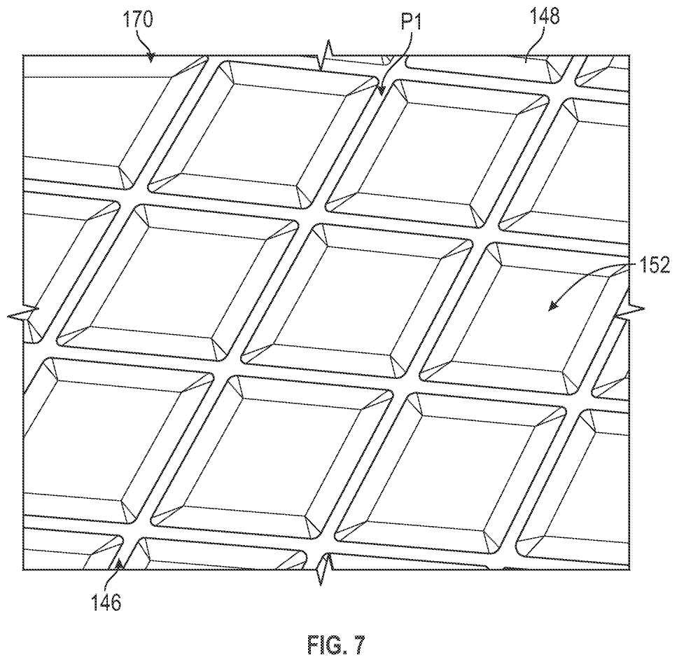

Referring to FIG. 7, there is shown a section 170 of the outer (front) face region 106 of the applique 146 of FIG. 6, to be placed onto the molding surface 204 of the molding cavity 202 of mold 200. As shown, while the thermoformed applique 146 includes pleats 152 and stitch paths P, the applique 146 does not include stitch lines L1-L4, and hence does not include any stitches 160.

Referring to FIG. 8, there is shown the rear side 156 of the applique 146 after the applique 146 has been loaded onto the molding surface 204 of the molding cavity 202 of mold 200.

Once the applique 146 has been loaded onto the molding surface 204 and into the molding cavity 202 of mold 200, the mold 200 is closed and plastic 200 to form the platform 120 is injected into the molding cavity 202 of the mold 200. During injection, the plastic contacts the molding surface 204 in the platform front face region 104 of the article 100, as well as the rear side 156 of the applique 146 in the applique front face region 106 of the article 106, to which the injected molded plastic bonds to the rear side 156 of the applique 146. Additionally, due to the molding pressures, the applique 146 deforms/stretches in the region 158 overlying the stitch recesses 216 of the molding surface 204 and enters the stitch recesses 216, As a result of the deformation/stretching of the region 158 of the applique 146 overlying the stitch recesses 216 into the stitch recesses 216, the region 158 of the applique 146 stress-whitens to form stitches 160 of a different color which is lighter, i.e. a color closer to white (which may be white), than an initial color of the region 158 (and a bordering region of the stitch paths P1-P4) prior to formation of the stitches 160. As such, given the arrangement of the stitch recesses 216, such forms a plurality of stitches 160 of the stitch lines L1-L4, arranged end to end along the stitch paths P1-P4.

As best shown by FIG. 3, the plurality of faux stitch lines L1-L4 each comprise a respective plurality of the faux stitches 160, with each faux stitch 160 of the respective plurality of faux stitches 160 comprising a respective stress-whitened region 158 of the applique 146 and the plurality of faux stitch lines L1-L4 completely surrounding the plurality of raised pleats 152.

Thus, a method to form a plastic article with faux stitching is provided, with the method comprising inserting an applique 146 having a front side 148 and a rear side 156 opposite the front side 148 in a molding cavity 202 of an injection mold 200, wherein the applique 146 is formed of a thermoformed plastic sheet; injecting plastic into the molding cavity 202, which forms an injection molded plastic platform 120, with the rear side 156 of the applique 146 bonded with the platform 120; and forming at least one faux stitch line L1-L4 on the front side 148 of the applique 146, wherein the at least one faux stitch line L1-L4 comprises faux stitches 160, wherein the faux stitches 160 each comprise a stress-whitened region 158 of the applique 146 formed during injecting of the plastic into the molding cavity 202.

While a preferred embodiment of the present invention(s) has been described, it should be understood that various changes, adaptations and modifications can be made therein without departing from the spirit of the invention(s) and the scope of the appended claims. The scope of the invention(s) should, therefore, be determined not with reference to the above description, but instead should be determined with reference to the appended claims along with their full scope of equivalents. Furthermore, it should be understood that the appended claims do not necessarily comprise the broadest scope of the invention(s) which the applicant is entitled to claim, or the only manner(s) in which the invention(s) may be claimed, or that all recited features are necessary.

### LISTING OF REFERENCE CHARACTERS

10 motor vehicle
12 flooring
100 plastic article
102 outer (front) face
104 platform front face region
106 applique front face region
120 platform
122 platform base/foundation wall
124 platform perimeter rim
126 platform front side
146 applique
148 applique front side
150 applique section
152 applique pleat
154 pleat front surface
156 applique rear side
158 stress-whitened region
160 stitch
162 stitch length
164 stitch width
166 stitch spacing
168 stitch path width
170 applique section
200 mold
202 molding cavity
204 molding surface
210 molding surface section
212 pleat recess
214 stitch path supports
216 stitch recess
L1-L4 stitch line
P1-P4 stitch path
S1-S4 pleat sides

What is claimed is:

1. A plastic article with faux stitching, comprising:
an applique having a front side and a rear side opposite the front side, and formed of a thermoformed plastic sheet;
an injection molded plastic platform;
wherein the applique is insert-molded to the platform with the rear side of the applique bonded with the platform;
wherein at least one faux stitch line is formed on the front side of the applique;
wherein the at least one faux stitch line comprises a plurality of faux stitches; and
wherein each faux stitch of the plurality of faux stitches comprises a stress-whitened region of the applique.

2. The article of claim 1, wherein:
the front side of the applique further includes a plurality of raised pleats.

3. The article of claim 2, wherein:
the at least one faux stitch line at least partially surrounds at least one raised pleat of the plurality of raised pleats.

4. The article of claim 2, wherein:
the at least one faux stitch line is disposed between adjacent raised pleats of the plurality of raised pleats.

5. The article of claim 2, wherein:
the at least one faux stitch line is disposed on at least one stitch path;
wherein the at least one stitch path is disposed between adjacent raised pleats of the plurality of raised pleats; and
wherein the at least one stitch path borders the adjacent raised pleats.

6. The article of claim 2, wherein:
the at least one faux stitch line comprises a plurality of faux stitch lines;
wherein the plurality of faux stitch lines each comprise a respective plurality of the faux stitches;
wherein each faux stitch of the respective plurality of faux stitches comprises a respective stress-whitened region of the applique; and
the plurality of faux stitch lines completely surround the plurality of raised pleats.

7. The article of claim 2, wherein:
the plurality of raised pleats each have a matching polygon shape.

8. The article of claim 7, wherein:
the polygon shape is a quadrilateral shape.

9. The article of claim 6, wherein:
the plurality of faux stitch lines are disposed on a plurality of respective stitch paths;
wherein the plurality of respective stitch paths are disposed between respective adjacent raised pleats of the plurality of raised pleats; and
wherein the plurality of respective stitch paths completely border the respective adjacent raised pleats.

10. The article of claim 1, wherein:
the injection molded plastic platform is formed of an elastomer; and/or
the injection molded plastic platform has a thickness in a range of 1.5 mm to 3.5 mm.

11. The article of claim 1, wherein:
the thermoformed plastic sheet is formed of a thermoplastic; and/or
the thermoformed plastic sheet has a thickness in a range of 0.1 mm to 1.5 mm.

12. The article of claim 1, wherein:
the article has an outer face having a region provided by the front side of a plastic applique and a region provided by a front side of the injection molded plastic platform, which is adjacent the front side of the plastic applique.

13. The article of claim 1, wherein:
the faux stitches which each comprise a respective stress-whitened region of the applique each have a longitudinal length in a range of 1 mm to 4 mm, and/or a width perpendicular to the longitudinal length in a range of 0.1 mm to 0.9 mm.

14. The article of claim 1, wherein:
the faux stitches which each comprise a stress-whitened region of the applique each have a different color than a bordering region of the applique bordering the faux stitches.

15. The article of claim 1, wherein:
the plastic article is an interior trim article of a motor vehicle.

16. The article of claim 1, wherein:
the plastic article is a floor mat and/or a floor tray.

17. A method to form a plastic article with faux stitching, the method comprising:
inserting an applique having a front side and a rear side opposite the front side in a molding cavity of an injection mold, wherein the applique is formed of a thermoformed plastic sheet;
injecting plastic into the molding cavity, which forms an injection molded plastic platform, with the rear side of the applique bonded with the platform; and
forming at least one faux stitch line on the front side of the applique, wherein the at least one faux stitch line comprises faux stitches, wherein the faux stitches each comprise a stress-whitened region of the applique formed during injecting of the plastic into the molding cavity.

18. The method of claim 17, wherein:
the front side of the applique further includes a plurality of raised pleats prior to being inserted in the molding cavity of the injection mold; and
the at least one faux stitch line at least partially surrounds at least one pleat of the plurality of raised pleats.

19. The method of claim 18, wherein forming at least one faux stitch line on the front side of the applique, wherein the at least one faux stitch line comprises faux stitches, wherein the faux stitches each comprise a stress-whitened region of the applique formed during injecting of the plastic into the molding cavity further comprises:
forming a plurality of faux stitch line on the front side of the applique, wherein the plurality of faux stitch lines each comprises faux stitches, wherein the faux stitches each comprise a stress-whitened region of the applique formed during injecting of the plastic into the molding cavity; and
wherein the plurality of faux stitch lines completely surround the plurality of raised pleats.

20. The method of claim 17, further comprising:
the article having an outer face having a region provided by the front side of a plastic applique and a region provided by a front side of the injection molded plastic platform, which is adjacent the front side of the plastic applique.
